(19) United States
(12) Patent Application Publication
(10) Pub. No.: US 2010/0044005 A1
(43) Pub. Date: Feb. 25, 2010

(54) COOLANT PUMPING SYSTEM FOR MOBILE ELECTRONIC SYSTEMS

(75) Inventors: Michel Bruno, Zurich (CH); Thomas Brunschwiler, Canton Zurich (CH); Urs Kloter, Dietikon (CH); Ryan J. Linderman, Pasadena, CA (US); Erich Ruetsche, Pfaeffikon (CH)

Correspondence Address: Cantor Colburn LLP-IBM Europe, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/194,973

(22) Filed: Aug. 20, 2008

(51) Int. Cl. B60H 1/32

(52) U.S. Cl. 165/44; 62/241

(57) ABSTRACT

A coolant pumping system for a mobile electronic system includes a coolant reservoir containing a coolant, a heat exchanger member fluidly connected to the coolant reservoir, and a mass moveably mounted to the mobile electronic system. The mass is moved along at least one axis in response to at least one of accelerations and orientation changes of the mobile electronic system. The coolant system further includes a force transfer member operatively connected between the mass and the coolant reservoir. The force transfer member urges the coolant from the coolant reservoir through the heat exchanger member in response to movements of the mass.

### BACKGROUND

This invention relates to the art of coolant pumping systems and, more particularly, to a coolant pumping system for mobile electronic systems.

Conventional electronic systems rely on conduction and/or convection cooling systems. Conduction cooling systems employ heat sinks that pass heat from an electronic component to a plurality of fins. Air passing across the fins carries away the heat. The air is either forced across the fins by a fan, or allowed to passively carry away any accumulated heat. Many newer electronic systems, such as computers, both desktop models and servers, employ a liquid coolant to carry away heat.

In addition to cooling systems, many electronics systems utilize optimization schemes to minimize power consumption. In such cases, the cooling systems must be capable of maintaining low temperatures associated with low power or stand-by modes when the electronic system is operating at peak loads. In order to provide sufficient liquid cooling at peak loads, pump systems and associated liquid cooling components are often oversized.

### SUMMARY

In accordance with exemplary embodiments of the invention, a coolant pumping system for a mobile electronic system includes a coolant reservoir containing a coolant, a heat exchanger member fluidly connected to the coolant reservoir, and a mass moveably mounted to the mobile electronic system. The mass is moved along at least one axis in response to at least one of acceleration and orientation changes of the mobile electronic system. The coolant system further includes a force transfer member operatively connected between the mass and the coolant reservoir. The force transfer member urges the coolant from the coolant reservoir through the heat exchanger member in response to movements of the mass.

In accordance with another exemplary embodiment of the invention a method of pumping coolant to a mobile electronic system includes moving the mobile electronic system to generate acceleration forces, shifting a mass moveably mounted to the mobile electronic system in response to the acceleration forces with the shifting mass creating work, and transferring the work through a force transfer member operatively connected to a coolant reservoir. The force transfer member urges coolant from the coolant reservoir through a heat exchanger member associated with the mobile electronic system.

Additional features and advantages are realized through the techniques of exemplary embodiments of the present invention. Other embodiments and aspects of the invention are described in detail herein and are considered a part of the claimed invention. For a better understanding of the invention with advantages and features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a mobile electronics system including a coolant pumping system in accordance with exemplary embodiments of the invention;

FIG. 2 illustrates a coolant pumping system in accordance with one exemplary embodiment of the invention;

FIG. 3 illustrates a coolant pumping system in accordance with another exemplary embodiment of the invention; and

FIG. 4 illustrates a coolant pumping system in accordance with yet another exemplary embodiment of the invention.

The detailed description explains the exemplary embodiments of the invention, together with advantages and features, by way of example with reference to the drawings.

### DETAILED DESCRIPTION

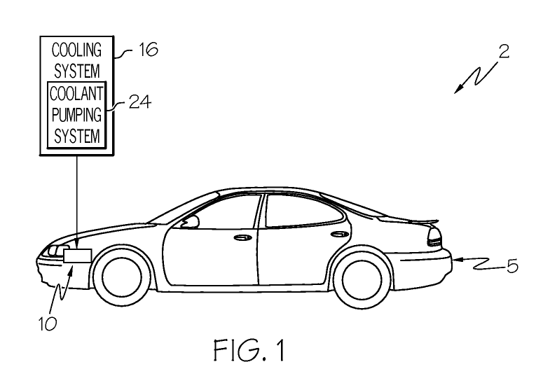

With initial reference to FIG. 1, a mobile electronic system, constructed in accordance with exemplary embodiments of the invention is indicated generally at 2. Mobile electronics system 2 is illustrated in the form of a vehicle 5 having an on-board electronics system 10 including a plurality of electronic components (not shown). At this point it should be understood that vehicle 5 can take on a variety of forms such as, but not limited to, a conventional internal combustion vehicle, a hybrid vehicle, as well as a completely electronic vehicle or any vehicle containing electronic components. More over, mobile electronics system 2 can also take a variety of forms such as, but not limited to, mobile computing devices, mobile video devices, as well as various consumer electronics devices. In any event, electronics system 10 includes a cooling system 16 having a coolant pumping system 24.

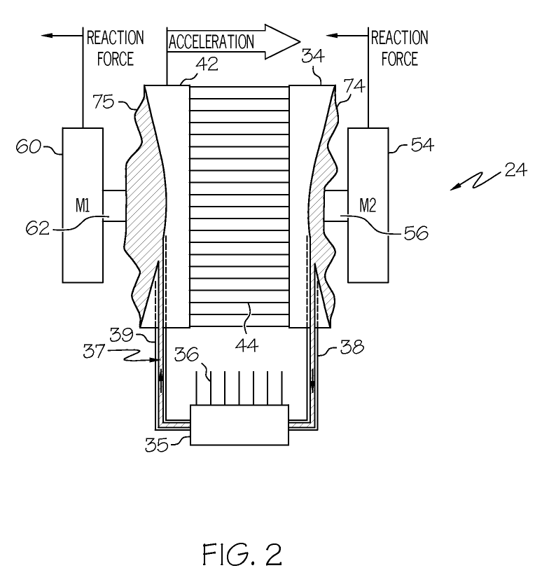

Reference will now be made to FIG. 2 in describing coolant pumping system 24 constructed in accordance with exemplary embodiments of the invention. As shown, coolant pumping system 24 includes a first coolant reservoir 34 fluidly connected to a heat exchanger member 35. Heat exchanger member 35 is provided with a plurality of fins 36 and is associated with electronics system 10 to facilitate heat removal. First coolant reservoir 34 is coupled to heat exchanger member 35 via a first conduit 37. More specifically, first conduit 37 includes a first section 38 extending between first reservoir 34 and heat exchanger member 35 and a second conduit 39 that extends between heat exchanger member 35 and a second coolant reservoir 42. In the exemplary embodiment shown, first coolant reservoir 34 is coupled to second coolant reservoir 42 via a plurality of fins 44. Fins 44 are exposed to an air flow so as to facilitate heat removal from coolant contained within each reservoir 34, 42.

In further accordance with the exemplary embodiment shown, coolant pumping system 24 includes a first mass 54 operatively coupled to first coolant reservoir 34 via a first force transfer member 56. At this point it should be understood that the term “mass” should be construed to include a designated mass associated with pumping system 24 or another component such as, but not limited to, a battery, or chassis component. Similarly, a second mass 60 is operatively coupled to second coolant reservoir 42 via a second force transfer member 62. Each mass 54, 60 is moveably mounted relative to vehicle 5. In this manner, forces developed though accelerations or movements of vehicle 5 cause each mass 54 and 60 to shift and thus create work. The work is transferred to corresponding ones of force transfer members 56 and 62. Each force transfer member 56 and 62 acts upon respective ones of coolant reservoirs 34 and 42 urging coolant through first conduit 37. More specifically, each coolant reservoir 34 and 42 includes a corresponding flexible membrane portion 74 and 75. Force transfer members 56 and 62 act on respective ones of flexible membranes 74 and 75 to urge coolant from corresponding ones of reservoirs 34 and 42. With this configuration, the coolant passes from one of first and second reservoirs 34 and 42, through conduit 37 to heat exchanger member 35. The coolant absorbs heat from electronic system 10 via heat exchanger member 35 and moves to the other of first and second coolant reservoirs 34 and 42. At this point, air passing over fins 44 carries away heat entrained in the coolant.

In this manner, reciprocating movement of masses 54 and 60 resulting from acceleration forces generated by vehicle 5 create an oscillating pumping system that delivers coolant to cool temperatures at electronic system 10. That is, in the case of, for example, hybrid vehicles, electronic system 10 reaches peak loads during accelerations and decelerations. By tying coolant movement to forces associated with high electrical loads, coolant pumping system 24 delivers coolant to heat exchanger member 35 during peak load periods in order to maintain low temperatures, e.g., temperatures realized during stand-by or non-peak periods, at the electronic components.

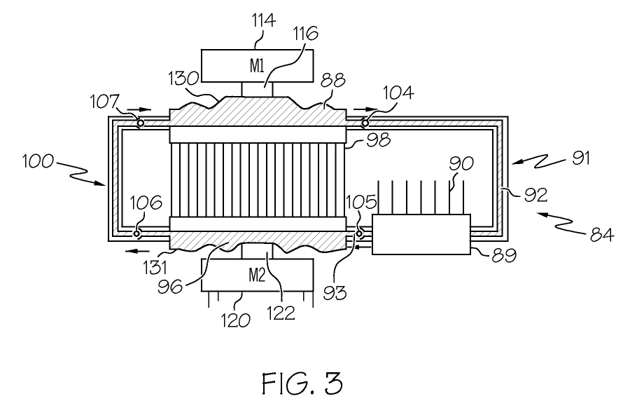

Reference will now be made to FIG. 3 in describing a coolant pumping system 84 constructed in accordance with another exemplary embodiment of the invention. As shown, coolant pumping system 84 includes a first coolant reservoir 88 fluidly connected to a heat exchanger member 89. In a manner similar to that described above, heat exchanger member 35 includes a plurality of fins 90 and is associated with electronics system 10 to facilitate heat removal. First coolant reservoir 88 is coupled to heat exchanger member 89 via a first conduit 91. First conduit 91 includes a first section 92 that extends between first reservoir 88 and heat exchanger member 89 and a second section 93 that extends between heat exchanger member 89 and a second coolant reservoir 96. Coolant pumping system 84 also includes a second conduit 100 that directly fluidly connects first and second coolant reservoirs 88 and 96. In addition, each conduit 91 and 100 includes a plurality of directional or one-way valves 104, 105 and 106, 107 respectively. One-way valves 104-107 ensure that coolant moving through coolant pumping system 84 travels in one direction. In any event, in a manner also similar to that described above, first coolant reservoir 88 is coupled to second coolant reservoir 96 via a plurality of fins 98. Fins 98 are exposed to an air flow so as to facilitate heat removal from coolant contained within each reservoir 88, 96.

In further accordance with the exemplary embodiment shown, coolant pumping system 84 includes a first mass 114 operatively coupled to first coolant reservoir 88 via a first force transfer member 116. Similarly, a second mass 120 is operatively coupled to second coolant reservoir 96 via a second force transfer member 122. Each mass 114, 120 is moveably mounted relative to vehicle 5. In this manner, forces developed though accelerations or movements of vehicle 5 cause each mass 114 and 120 to shift thereby creating work. The work is transferred to corresponding ones of force transfer members 116 and 122. Each force transfer member 116 and 122 acts upon respective ones of coolant reservoirs 88 and 96 urging coolant through first conduit 91. More specifically, each coolant reservoir 88 and 96 includes a corresponding flexible membrane portion 130 and 131. Force transfer members 116 and 122 act on respective ones of flexible membranes 130 and 131 to urge coolant from corresponding ones of reservoirs 88 and 96. The coolant passes from first and second reservoirs 88, through first section 92 to heat exchanger member 89. The coolant absorbs heat from electronic system 10 via heat exchanger member 89 and moves through second section 93 to second coolant reservoir 96. At the same time, coolant displaced from first coolant reservoir 88 is replenished by coolant from second coolant reservoir 96 via second conduit 100.

In this manner, reciprocating movement of masses 114 and 120 resulting from forces generated by vehicle 5 creates a unidirectional pulsating flow pump system that delivers coolant to cool temperatures at electronic system 10. That is, as note above, in, for example, hybrid vehicles, electronic system 10 reaches peak loads during accelerations and decelerations. By tying coolant movement to vehicle or system forces associated with high electrical loads, coolant pumping system 84 delivers coolant to heat exchanger member 89 during peak load periods in order to maintain low temperatures, e.g., temperatures realized during stand-by or non-peak periods, at the electronic components.

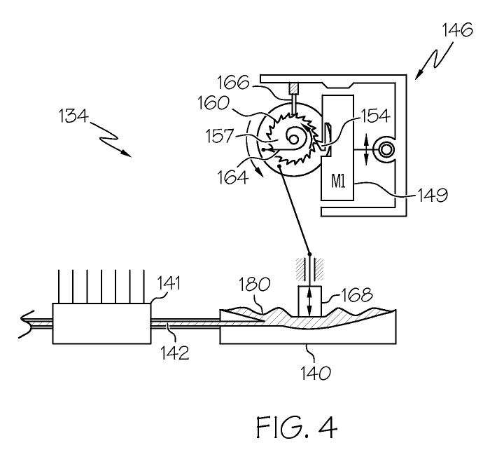

Reference will now be made to FIG. 4 in describing a coolant pumping system 134 constructed in accordance with yet another exemplary embodiment of the invention. As shown, coolant pumping system 134 includes a coolant reservoir 140 fluidly coupled to a heat exchanger member 141 via a conduit 142. Coolant pumping system 134 also includes a mechanical fixture 146 having a mass 149 including a tooth element 154. In a manner similar to that described above, mass 149 is movable in response to acceleration changes in vehicle 5. As shown, mass 149 is operatively coupled to a gear member 157 having a plurality of teeth members, one of which is indicated at 160. In turn, gear member 157 is coupled to a spring 164 and a latch 166. Spring 164 is connected to a force transfer member 168 that is operatively connected to coolant reservoir 140.

In accordance with the above-described arrangement, forces generated by accelerations or movements of vehicle 5 are transferred to mass 149. Mass 149, in response the forces, oscillates or moves within mechanical fixture 146 to load a tension onto a spring 164. More specifically, oscillations and movements of mass 149 act upon gear member 157. Gear member 157 rotates to load spring 164. Gear member 157 is held in place by latch 166 to maintain the load in spring 164. In this manner, latch 166 is selectively disengaged to release energy stored in spring 164. The energy stored in spring 164 acts upon force transfer member 168 to urge coolant through heat exchanger member 141. More specifically, coolant reservoir 140 includes a flexible membrane portion 180. Force transfer member 168 acts on flexible membrane 180 to urge coolant from reservoirs 140 through heat exchanger member 141.

In accordance with one aspect of the exemplary embodiment, the energy stored in spring 164 is exerted upon force transfer member 168 over an extended period of time, even after the accelerations and/or movements cease. At this point it should be understood that coolant pumping system 134 may include another mass system that acts upon another coolant reservoir. In this manner, coolant system 134 is readily adapted to both oscillating pumping systems and unidirectional pumping systems. Moreover, the use of multiple, separate spring systems enables coolant pumping system 134 to be fine tuned to match anticipated acceleration forces with required pumping rates. Once again it should be understood that by tying coolant movement to vehicle or system forces associated with high electrical loads, coolant pumping system 134 delivers coolant to heat exchanger member 141 during peak load periods in order to maintain low temperatures, e.g., temperatures realized during stand-by or non-peak periods, at the electronic components.

At this point it should be appreciated that the exemplary embodiments of the invention provide a coolant pumping system readily adaptable to meet cooling needs for mobile electronics systems. By tying coolant movement to vehicle or system forces associated with high electrical loads such as, but not limited to, changes in orientation or repetitive motions from a user, coolant pumping systems in accordance with exemplary embodiments of the invention deliver coolant of a reduced temperature relative to electronic components during peak load while still maintaining low temperatures associated with stand-by or non-peak periods. It should also be appreciated the mobile electronics system can take a variety of forms such as, but not limited to, vehicles such as internal combustion vehicles, hybrid vehicles, electric vehicles and the like as well as mobile computing devices, mobile video devices, as well as various consumer electronics devices.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

1. A coolant pumping system for a mobile electronic system comprising:
a coolant reservoir containing a coolant;
a heat exchanger member fluidly connected to the coolant reservoir;
a mass moveably mounted to the mobile electronic system, the mass being moved along at least one axis in response to at least one of acceleration and orientation changes of the mobile electronic system; and
a force transfer member operatively connected between the mass and the coolant reservoir, the force transfer member urging the coolant from the coolant reservoir through the heat exchanger member in response to movement of the mass.

2. The coolant pumping system according to claim 1, further comprising:
another coolant reservoir, the force transfer member urging the coolant from the coolant reservoir through the heat exchanger member and into the another coolant reservoir.

3. The coolant pumping system according to claim 2, further comprising a first conduit fluidly linking the coolant reservoir and the another coolant reservoir through the heat exchanger member.

4. The coolant pumping system according to claim 3, further comprising: a second conduit directly connecting the coolant reservoir and the another coolant reservoir.

5. The coolant pumping system according to claim 4, further comprising: at least one one-way valve fluidly connected to the second conduit, the at least one one-way valve allowing coolant to flow through the second conduit only from the another coolant reservoir to the coolant reservoir.

6. The coolant pumping system according to claim 2, further comprising:
another mass moveably mounted to the mobile electronic system, the another mass being moved along at least one axis in response to at least one of accelerations and orientation changes of the mobile electronic system; and
another force transfer member operatively connected between the another mass and the another coolant reservoir, the another force transfer member urging coolant from the another coolant reservoir back to the coolant reservoir in response to movement of the another mass.

7. The coolant pumping system according to claim 1, further comprising: a gear member operatively connecting the mass and the force transfer member.

8. The coolant pumping system according to claim 7, wherein the mass includes a tooth element, and the gear member including a tooth member, the tooth element engaging with the tooth member to transfer movement of the mass to the force actuator.

9. The coolant pumping system according to claim 7, further comprising: a spring element operatively coupled between the gear member and the force transfer member, the spring element storing energy resulting from movement of the mass for later transfer to the force transfer member.

10. The coolant pumping system according to claim 1, wherein the mobile electronic system forms part of a vehicle.

11. A method of pumping coolant to a mobile electronic system, the method comprising:
moving the mobile electronic system to generate forces;
shifting a mass moveably mounted to the mobile electronic system in response to the forces generated by moving the mobile electronic system, the shifting mass creating work; and
transferring the work through a force transfer member operatively connected to a coolant reservoir, the force transfer member urging coolant from the coolant reservoir through a heat exchanger member associated with the mobile electronic system.

12. The method of claim 11, further comprising:
urging the cooling from the coolant reservoir through the heat exchanger member to another coolant reservoir.

13. The method of claim 12, further comprising: passing the coolant through a first conduit fluidly linking the coolant reservoir and the another coolant reservoir through the heat exchanger member.

14. The method of claim 13, further comprising: passing the coolant through a second conduit directly connecting the coolant reservoir and the another coolant reservoir.

15. The method of claim 14, further comprising: passing the coolant through at least one one-way valve fluidly connected to the second conduit, the at least one one-way valve allowing coolant to flow through the second conduit only from the another coolant reservoir to the coolant reservoir.

16. The method of claim 12, further comprising:
displacing another mass moveably mounted to the mobile electronic system, the another mass being displaced by coolant entering the another coolant reservoir.

17. The method of claim 16, further comprising:
further moving the mobile electronic system to generate additional forces;
shifting the another mass in response to the additional forces, the shifting of the another mass creating additional work; and
transferring the additional work through another force transfer member operatively connected to the another coolant reservoir, the another force transfer member urging coolant from the another coolant reservoir back to the coolant reservoir.

18. The method of claim 11, further comprising: transferring the work from the mass to a gear member operatively connecting the mass and the force transfer member.

19. The method of claim 18, further comprising, storing the work in a spring element operatively coupled between the gear member and the force transfer member.

20. The method of claim 19, further comprising: selectively releasing the work stored in the spring element into the force transfer member to urge the coolant from the coolant reservoir through the heat transfer member.
